(19) United States
(12) Patent Application Publication
(10) Pub. No.: US 2019/0393971 A1
(43) Pub. Date: Dec. 26, 2019

(54) Time Division Multiple Access Network Device

(71) Applicant: To Chin, Zhubei (TW)

(72) Inventor: To Chin, Zhubei (TW)

(21) Appl. No.: 16/446,687

(22) Filed: Jun. 20, 2019

(30) Foreign Application Priority Data
Jun. 20, 2018 (TW) 107121175

(51) Int. Cl. H04J 3/06; H04L 12/911

(52) U.S. Cl. CPC H04J 3/0635; H04L 69/325; H04L 47/821

(57) ABSTRACT

A TDMA network device compatible with other networks is disclosed. It needs no additional control signals. Based on received data packets or data volume to process time synchronization and time division based on received data and prepared in advance, it is to ensure that every node can calculate approximate time allocation and pass the time division features to the next layer of network.

### FIELD OF THE INVENTION

The Time Division Multiple Access (TDMA) network device of the present invention is built upon the network data layer, belonging to a network technology compatible with ISO LAYER 3 above in other networks.

### BACKGROUND OF THE INVENTION

Multiplex modes of networks are pre-allocated modes, such as FDMA, TDMA and CDMA, and first-come-first-served modes, such as CSMA/CD. For a general telephone network, considering the user experience, it processes bandwidth management by using a pre-allocated method. The equipment cost higher. However, data network is unstable due to larger flow. Hence, most of them use an easy and cheap communication protocol of first-come-first-served mode. For the technology such as VOIP, is uses relatively simple and cheap data network to provide telephone service. Therefore, it needs bandwidth management technology to improve user experience. Technologies for existing first-come-first-served network equipment to achieve TDMA all processes time synchronization by controlling packets. Every node in the network is allowed to process time allocation. This method can not concatenate equipment which doesn't support it.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

A TDMA network device is provided in the present invention. Based on the time data packets arrive and applied time synchronization signals for sending data packets, all nodes use the same algorithm for time allocation to ensure consistent allocation of transmitting time in all nodes, achieving TDMA.

A TDMA network device, comprises: a network module, receiving and sending data which are transmitted in packets; a time allocation module, classifying and counting specific tags after packets are received, determining a length of each time slot of different classifications, and sorting time slots according to values of the tags sequentially before beginning to try to align real receiving time and allocated time slots according to receiving time of different classification packets to find out alignment points with the least error for timing synchronization of transmission, wherein the packets confirming to the tags are transmitted only during the time slot belonging to the tags.

Preferably, the specific tags may be at least one selected from the followings: receiving address, sending address, packet priority, receiving communication port, sending communication port and communication protocol.

Preferably, the time allocation module may select at least one from the followings to calculate the length of the time slot: the specific tags, data volume of the classification and number of the packets of the classification.

Preferably, the counting may be processed with at least one selected from the followings: data volume and number of the packets.

Preferably, the least error may comprise the least number of the packets in wrong time slots or the minimum amount of data in wrong time slots.

Preferably, when a maximum number of the time slots that the time allocation module supports is smaller than a number of the classification, select the classification of time slot according to a priority of the classifications, and allocate the rest classifications to the same time slot.

Preferably, a priority of the classification may be calculated from at least one selecting from the followings: the specific tags, data volume of the classification and number of the packets of the classification.

### BRIEF DESCRIPTION OF THE DRAWINGS

FIG. 1 is a schematic diagram of implementing the present invention in a typical wireless network access point.

FIG. 2 shows a communication network composed of a wireless network and a wired network.

FIG. 3 is a classification table of two independent TDMAs showing an embodiment having two different networks.

FIG. 4 is an example of time synchronization, using a number of the packets for alignment.

FIG. 5 is an example of time synchronization, using a number of the packets for alignment.

FIG. 6 is an example of time synchronization, using data volume for alignment.

FIG. 7 is an example of calculating a length of the time slots, using a communication protocol and addresses for classification.

FIG. 8 is an example of calculating the time slot allocation priority, using packet priority and addresses for classification.

### DETAILED DESCRIPTION OF THE PREFERRED EMBODIMENTS

The present invention will now be described more specifically with reference to the following embodiments.

FIG. 1 is a schematic diagram of implementing the present invention in a typical wireless network access point. The present invention can be implemented in the device. Packets come from a wireless network device 100 or a wired network device 101. Since the bandwidth of the two networks are independent, time allocation of each one is independently calculated. A time allocation module can be implemented in the form of software over a processor 102. Packets are classified and counted for the IP address tags of the packets in the time allocation module. Classification is processed by combining source IP and target IP. For example, 10.1.1.1 to 10.1.1.2 is a classification and 10.1.1.1 to 10.1.1.3 is another classification. They are stored in a packet queue 103. The processor 102 passes the counted data to the time allocation module, obtaining transmitted time slots allocated for each classification. For example, there are totally 10 classifications. Each classification is allocated a time slot of 10 ms. Then, combine the source IP and target IP into a 64-bit integer for sequentially sorting. The processor 102 then finds out packets conforming to the classification in the queue in the time slot of each classification of the wired network. Send the packets from the wired network 101 and finds out packets conforming to the classification in the queue in the time slot of each classification of the wireless network. Send the packets from the wireless network 100.

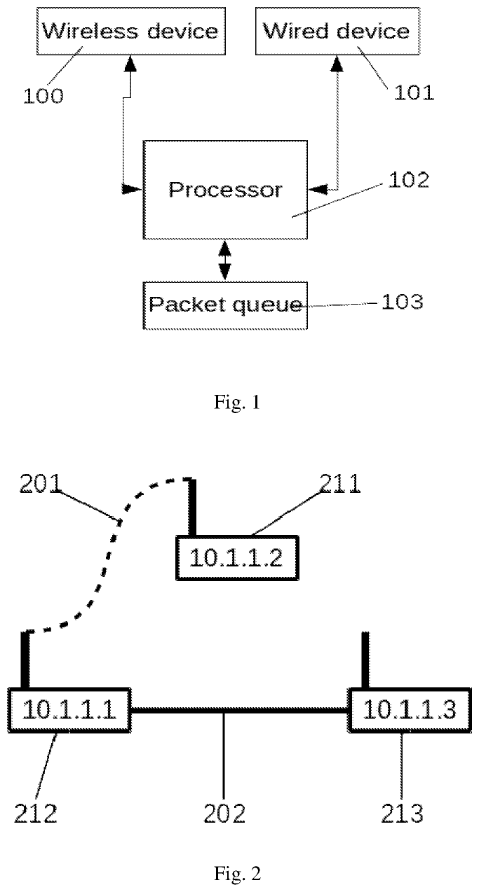

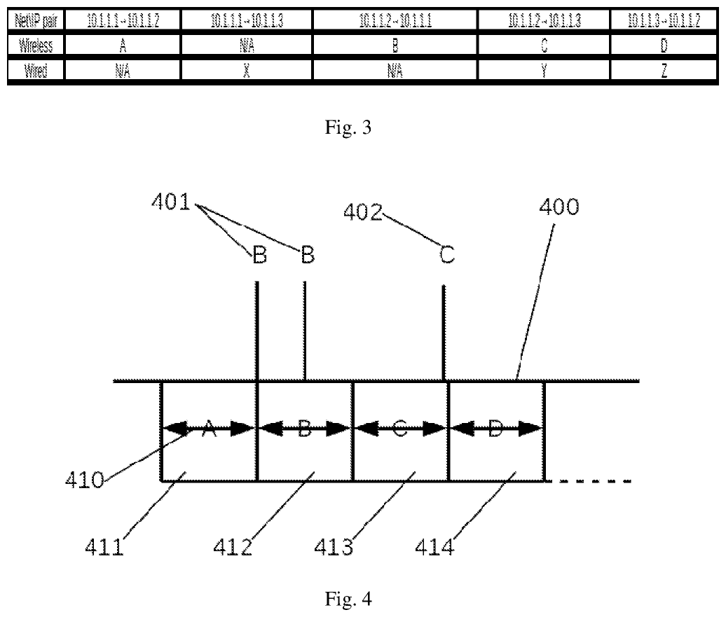

FIG. 2 shows a communication network composed of a wireless network and a wired network. It is composed by an access point like the one in Fig. There are a wireless network 201 and a wired network 202. Two networks have their own independent TDMA time allocation, respectively. An IP of an access point 211 is 10.1.1.2. An IP of an access point 212 is 10.1.1.1. An IP of an access point 213 is 10.1.1.3. Take the access point 212 connects to both two networks at the same time as an example. If IP addresses are used to process time allocation and communication time between IPs are fairly allocated, then a classification table can be obtained as shown in FIG. 3. Different source IP and target IP address are classified as different classification.

FIG. 4 is an example of time synchronization, using a number of the packets for alignment. Symbol 400 is the timeline. Symbol 410 refers to time slots of each classification. Real time of receipt of classification B packets is presented by symbol 401. Time of receipt of classification C packets is presented by symbol 402. The time allocation module aligns the beginning of the transmitted time slot B with a real receiving time of a first received B. It is able to obtain that the receiving time of two Bs are in the allocated time slot with error of 0. A receiving time of C is also in the allocated time slot. Therefore, this alignment is the least error solution.

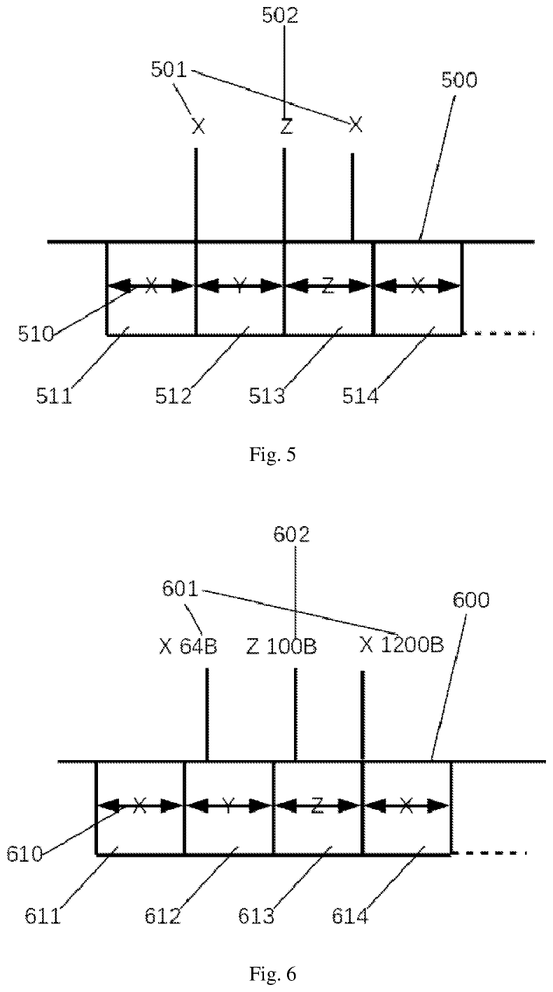

FIG. 5 is another example of time synchronization, using the number of the packets for alignment. Symbol 500 is the timeline. Symbol 510 refers to time slots of each classification. Real time of receipt of classification X packets is presented by symbol 501. Time of receipt of classification Z packets is presented by symbol 502. The time allocation module aligns the end of the transmitted time slot X with a real receiving time of a received first X. It is able to obtain that the receiving time of one X is in the allocated time slot with error of 0. A receiving time of Z is also in the allocated time slot with error of 0. The second X is also very close to a time slot of the next X. Therefore, this alignment is the least error solution.

FIG. 6 is another example of time synchronization, using data volume for alignment. Symbol 600 is the timeline. Symbol 610 refers to time slots of each classification. Real time of receipt of classification X packets is presented by symbol 601. First X packet has 64 Bytes and second X packet has 1200 Bytes. Time of receipt of classification Z packet is at 602 with 100 Bytes of data. Time error needs to be multiplied by the data size to calculate. The time allocation module aligns the beginning of the received time slot X with a real receiving time of a received second X. It is able to obtain that a receiving time of the 1200 Bytes X is in the allocated time slot with error of 0. A receiving time of Z is also in the allocated time slot with error of 0. The first X is also very close to a time slot of the next X. The error of 64 is a small gap. Therefore, this alignment is the least error solution.

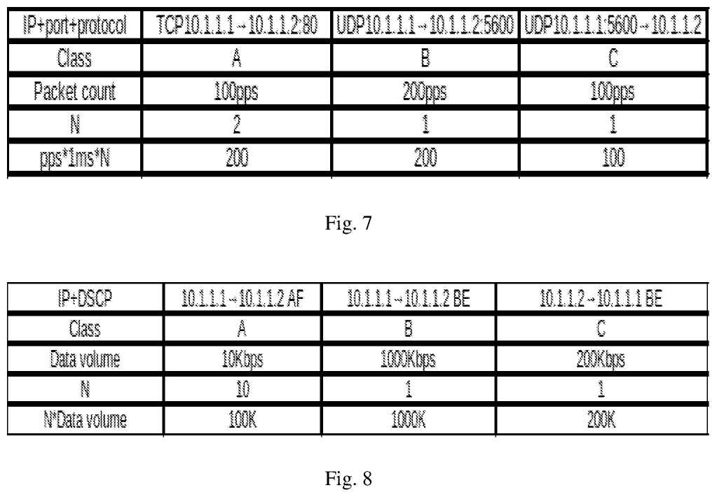

FIG. 7 is an example of calculating the length of the time slots, using a communication protocol and addresses for classification. The length of time slot equals weighted N*the number of packets per second (pps)*1 ms. Here, N is 2 for HTTP communication protocol (TCP port 80) and 1 for RTP communication protocol (UDP port 5600). Hence, the last allocation of the time slots is A transmitted for 200 ms, B transmitted for 200 ms, and C transmitted for 100 ms last for every cycle.

FIG. 8 is an example of calculating the time slot allocation priority, using packet priority and addresses for classification. The packet priority is IP DSCP. A priority is weighted N*bytes per second (bps). Here, N is classified as 10 for AF and 1 for BE. Hence, the last allocation priority is B>C>A. If only 2 time slots are supported, it becomes a single time slot B. C and A share another time slot.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A TDMA network device, comprising:
a network module, receiving and sending data which are transmitted in packets;
a time allocation module, classifying and counting specific tags after packets are received, determining a length of each time slot of different classifications, and sorting time slots according to values of the tags sequentially before beginning to try to align real receiving time and allocated time slots according to receiving time of different classification packets to find out alignment points with the least error for timing synchronization of transmission, wherein the packets confirming to the tags are transmitted only during the time slot belonging to the tags.

2. The TDMA network device according to claim 1, wherein the specific tags are at least one selected from the followings: receiving address, sending address, packet priority, receiving communication port, sending communication port and communication protocol.

3. The TDMA network device according to claim 1, wherein the time allocation module selects at least one from the followings to calculate the length of the time slot: the specific tags, data volume of the classification and number of the packets of the classification.

4. The TDMA network device according to claim 1, wherein the counting is processed with at least one selected from the followings: data volume and number of the packets.

5. The TDMA network device according to claim 1, wherein the least error comprises the least number of the packets in wrong time slots or the minimum amount of data in wrong time slots.

6. The TDMA network device according to claim 1, wherein when a maximum number of the time slots that the time allocation module supports is smaller than a number of the classification, select the classification of time slot according to a priority of the classifications, and allocate the rest classifications to the same time slot.

7. The TDMA network device according to claim 1, wherein a priority of the classification is calculated from at least one selecting from the followings: the specific tags, data volume of the classification and number of the packets of the classification.
